(19) United States
(12) Patent Application Publication
(10) Pub. No.: US 2024/0190500 A1
(43) Pub. Date: Jun. 13, 2024

(54) STEERING INPUT DEVICE AND METHOD OF CONTROLLING THE SAME

(71) Applicant: HYUNDAI MOBIS CO., LTD., Seoul (KR)

(72) Inventors: Su Ju PARK, Yongin-si (KR); Bong Soo KIM, Yongin-si (KR)

(73) Assignee: HYUNDAI MOBIS CO., LTD., Seoul (KR)

(21) Appl. No.: 18/520,015

(22) Filed: Nov. 27, 2023

(30) Foreign Application Priority Data
Dec. 12, 2022 (KR) 10-2022-0172628
Feb. 22, 2023 (KR) 10-2023-0023869

(51) Int. Cl. B62D 5/04; B62D 1/12; B62D 5/00

(52) U.S. Cl. CPC B62D 5/0403; B62D 1/12; B62D 5/001

(57) ABSTRACT

A steering input device according to the present disclosure includes a grip part, a lower shaft engaged to the grip part and configured to be rotated by a rotation of the grip part, a torsion bar, an end portion of which is connected to the lower shaft, wherein the torsion bar is at least partially disposed in the lower shaft, a connection shaft connected to the torsion bar and configured to accommodate at least a part of the torsion bar, the connection shaft being connected to the lower shaft, a sensor configured to detect a rotation angle of the lower shaft or the connection shaft, and a motor shaft connected to the connection shaft and configured to be rotated by a motor.

### CROSS-REFERENCE TO RELATED APPLICATION

This application claims priority from and the benefit of Korean Patent Application No. 10-2022-0172628, filed on Dec. 12, 2022, Korean Patent Application No. 10-2023-0023869, filed on Feb. 22, 2023, which are hereby incorporated by reference for all purposes as if set forth herein.

### BACKGROUND

### Field

Exemplary embodiments of the present disclosure relate to a steering input device, a method of controlling the same, and a method of manufacturing the same, and more particularly, to a steering input device using a grip, a method of controlling the same, and a method of manufacturing the same.

### Discussion of the Related Art

In general, a steering system of a vehicle is mechanically connected from a handle, which is configured to input a steering angle, to a tie rod configured to rotate a tire. Because the steering system is mechanically connected from the handle to the tie rod, a volume occupied by mechanical components is large, which causes significant difficulty in using a space in the vehicle.

In order to cope with the difficulty, a steer-by-wire system has been developed, which connects a handle and a tie rod electrically, instead of mechanically, and controls a rotation of a tire by means of an actuator. The utilization of the space in the vehicle has been improved by virtue of the development of the steer-by-wire system, but the utilization of an internal space, in which a user is positioned, has not been improved because of a size of the handle.

Therefore, there is a need for a steering input device that has a smaller volume and is more convenient to manipulate than the handle in the related art. However, the steering input device having a new structure is difficult to assemble, and there is an error in sizes of constituent components of the steering input device. Therefore, the steering input device needs to have improved assemblability, and the error in sizes of the constituent components of the steering input device needs to be minimized.

The background technology of the present disclosure is disclosed in Korean Patent No. 10-2431451 (registered on Aug. 8, 2022 and entitled “STEER-BY-WIRE TYPE STEERING SYSTEM FOR VEHICLE).

### SUMMARY

Various embodiments are directed to a steering input device with a small volume and improved convenience.

Various embodiments are directed to an electronic control steering system that improves stability of a vehicle and convenience for a user.

Various embodiments are directed to a method of manufacturing an electronic control steering system that improves stability of a vehicle and convenience for a user.

Various embodiments are directed to a steering input device with improved assemblability and a method of manufacturing the same.

Various embodiments are directed to a steering input device with a reduced error of constituent components, and a method of manufacturing the same.

A steering input device according to the present disclosure includes: a grip part; a lower shaft engaged to the grip part and configured to be rotated by a rotation of the grip part; a torsion bar, an end portion of which is connected to the lower shaft, wherein the torsion bar is at least partially disposed in the lower shaft; an upper shaft connected to the torsion bar, wherein the upper shaft is configured to accommodate at least a part of the torsion bar, the upper shaft being connected to the lower shaft; a sensor configured to detect a rotation angle of the lower shaft or the upper shaft; and a motor shaft connected to the upper shaft and coupled to a motor to be rotated by the motor.

The steering input device may further include: an input part housing accommodating at least a part of the grip part; a ball disposed in the input part housing and connected to the grip part; a guide bushing contacting with the ball in a direction opposite to the grip part; and a spring disposed in the input part housing and configured to elastically support the guide bushing in a direction toward the ball.

The sensor may detect torque applied to the torsion bar by a difference in rotational force between the upper shaft and the lower shaft.

A bushing groove may be formed in a portion of the guide bushing that is in contact with the ball, and the spring may press the guide bushing toward the ball so that the ball is in contact with the guide bushing.

The steering input device may further include: a plug disposed in the input part housing and configured to support the spring at a side opposite to the guide bushing; and a dry bushing disposed inside the guide bushing and outside the plug.

The steering input device may further include: a first port disposed outside the input part housing and connected to the sensor; and a second port connected to a motor controller disposed in a motor part housing that accommodates the motor shaft, in which the motor is configured to operate based on a signal inputted through the second port.

A method of controlling an electronic control steering system including a steering input device, a steering part, and a controller according to the present disclosure includes: detecting a speed of a vehicle; determine whether the detected speed of the vehicle is equal to or higher than a preset speed; and setting a total gear ratio value to a first value when the detected speed of the vehicle is equal to or higher than the preset speed, and setting the total gear ratio value to a second value, which is larger than the first value, when the detected speed of the vehicle is lower than the preset speed, in which the total gear ratio value is a ratio of a tire steering angle to a rotation angle of a grip part of the steering input device.

The method may include: detecting a rotation angle of the grip part; detecting a rotation angle and torque of a torsion bar of the steering input device and transmitting a signal to the steering part; setting the tire steering angle by operating the steering part in response to the signal transmitted to the steering part; detecting a position of a tire steered by the operation of the steering part and transmitting a signal related to the position of the tire to the steering input device; and setting a rotation angle of the grip part by operating a motor in response to the signal transmitted to the steering input device.

The transmitting of the signal related to the position of the tire to the steering input device may include: detecting a rotation angle and a torque of the torsion bar; synthesizing a signal transmitted to the steering part and a signal related to the position of the tire; and transmitting the synthesized signal to the steering input device.

A steering input device according to the present disclosure includes: a grip part; a connection part configured to be rotated by a rotation of the grip part; an input part housing accommodating the grip part and the connection part; and a reaction force generation part coupled to the input part housing and configured to generate a reaction force that varies depending on the rotation of the grip part, in which the reaction force generation part includes: a guide bushing being in contact with the grip part and configured to be moved by the rotation of the grip part; and a restriction pin configured to restrict a movement range of the guide bushing.

The reaction force generation part may include a plug coupled to the input part housing, and the restriction pin may be coupled to the plug such that a distance from the guide bushing is adjusted.

The reaction force generation part may include a plug nut, and the plug nut may be screw-coupled to the restriction pin, move in a length direction of the restriction pin, come into contact with the plug, and fix the restriction pin to the plug.

The reaction force generation part may include a spring, and the spring may be disposed between the guide bushing and the plug and press the guide bushing toward the grip part.

A ball may be provided below a grip shaft of the grip part, and the ball may be seated in a bushing groove formed in the guide bushing and move the guide bushing toward the restriction pin in accordance with a rotation of the grip shaft.

The steering input device may include: a sensor part configured to detect a rotation angle of the connection part; and a motor shaft connected to the connection part and configured to be rotated by a motor.

The plug may be inserted into the guide bushing, and the steering input device may include a dry bushing being in contact with the guide bushing and the plug and configured to reduce friction generated between the guide bushing and the plug.

A method of manufacturing a steering input device according to the present disclosure includes: disposing a grip part and a connection part connected to the grip part and configured to be rotated by a rotation of the grip part; disposing a guide bushing in an input part housing so that the guide bushing is in contact with the grip part and is moved by the rotation of the grip part; and disposing a reaction force generation part connected to the input part housing and configured to generate a reaction force that varies depending on the rotation of the grip part, in which the reaction force generation part includes: a guide bushing being in contact with the grip part and configured to be moved by the rotation of the grip part; and a restriction pin configured to restrict a movement range of the guide bushing.

The reaction force generation part may include a plug nut, a plug, and a spring, the plug may be coupled to the input part housing, the restriction pin may be coupled to the plug to adjust a distance from the guide bushing, the plug nut may be screw-coupled to the restriction pin, move in a length direction of the restriction pin, come into contact with the plug, and fix the restriction pin to the plug, and the spring may be disposed between the guide bushing and the plug and press the guide bushing toward the grip part.

The disposing of the reaction force generation part may include disposing the guide bushing so that the guide bushing is in contact with the grip part in a state in which the grip part is maximally rotated within an operating range; and disposing the restriction pin so that the restriction pin is in contact with the guide bushing in a state in which the guide bushing is in close contact with the grip part.

The electronic control steering system according to the present disclosure may have a small volume, which may improve the spatial utilization of the interior of the vehicle and improve the convenience for the user.

The steering input device and the method of manufacturing the same according to the present disclosure may improve the assemblability and reduce an error in sizes of the constituent components.

### BRIEF DESCRIPTION OF THE DRAWINGS

FIG. 1 is a perspective view of an electronic control steering system according to an embodiment of the present disclosure.

FIG. 2 is a perspective view of a steering input device according to the embodiment of the present disclosure.

FIG. 3 is a side view illustrating a lateral side of a part of the steering input device according to the embodiment of the present disclosure.

FIG. 4 is a cross-sectional side view of the steering input device according to the embodiment of the present disclosure.

FIG. 5 is a cross-sectional view of the steering input device according to the embodiment of the present disclosure taken in a direction perpendicular to a length direction.

FIG. 6 is an enlarged view of a part of the steering input device illustrated in FIG. 5.

FIG. 7 is a view illustrating a state in which a grip of the steering input device according to the embodiment of the present disclosure is moved.

FIG. 8 is an enlarged view of a part of the steering input device illustrated in FIG. 7.

FIG. 9 is a control flowchart for the steering input device according to the embodiment of the present disclosure.

FIG. 10 is a control flowchart for the electronic control steering system according to the embodiment of the present disclosure.

FIG. 11 is a flowchart for a method of manufacturing the steering input device according to the embodiment of the present disclosure.

### DETAILED DESCRIPTION

Hereinafter, an electronic control steering system, and a method of controlling the same, a steering input device, and a method of manufacturing the same will be described below with reference to the accompanying drawings through various exemplary embodiments. Here, thicknesses of lines, sizes of constituent elements, or the like illustrated in the drawings, may be exaggerated for clarity and convenience of description. In addition, the terms used below are defined in consideration of the functions in the present disclosure and may vary depending on the intention of a user or an operator or a usual practice. Therefore, such terms should be defined based on the entire contents of the present specification.

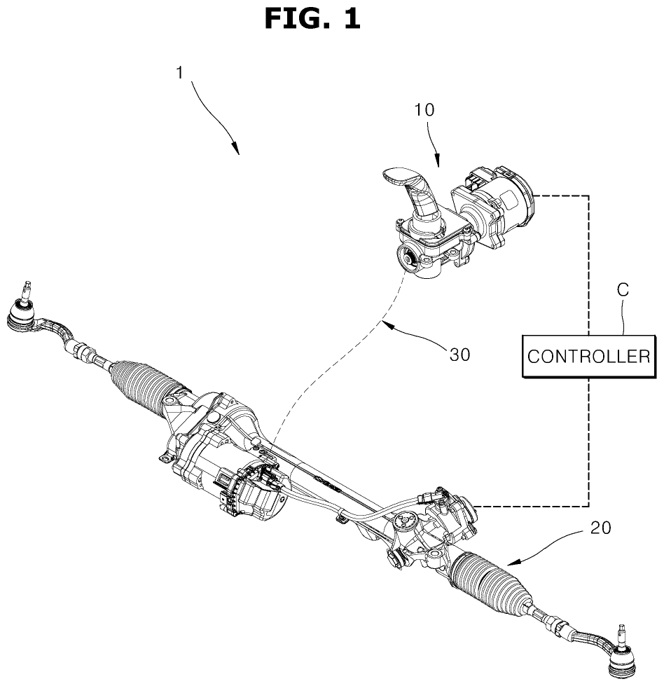

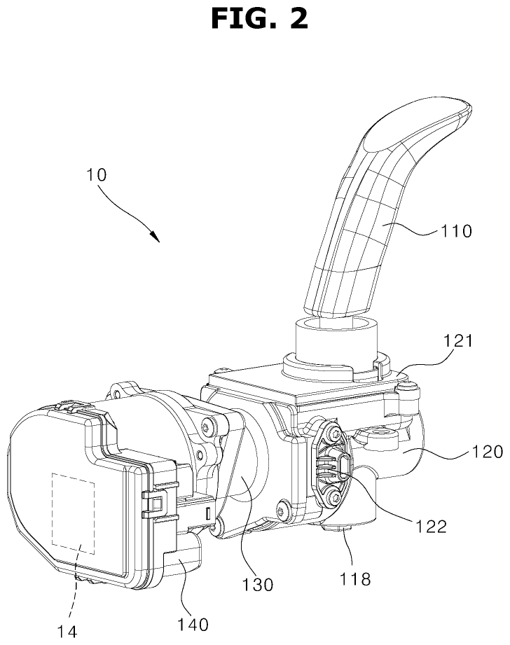

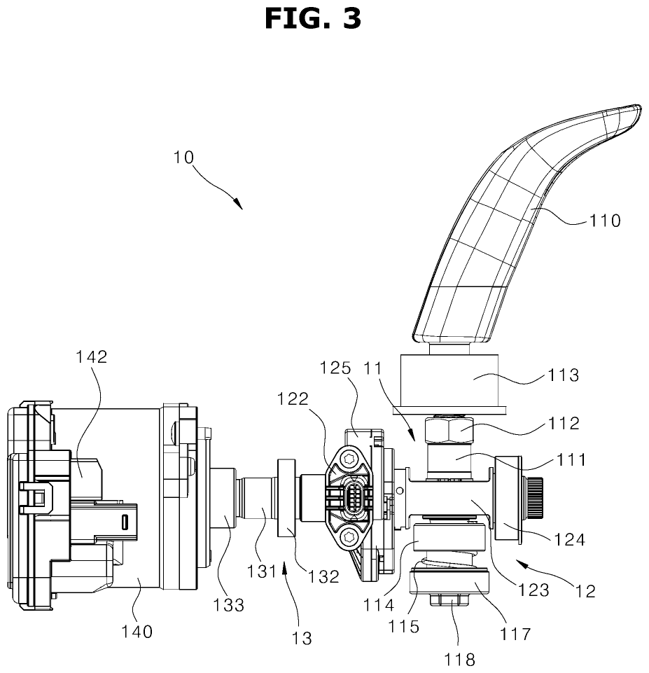

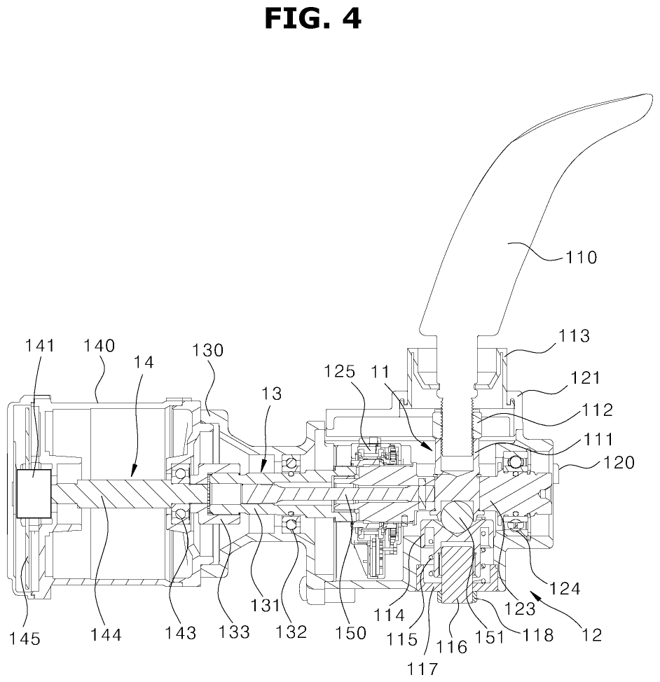

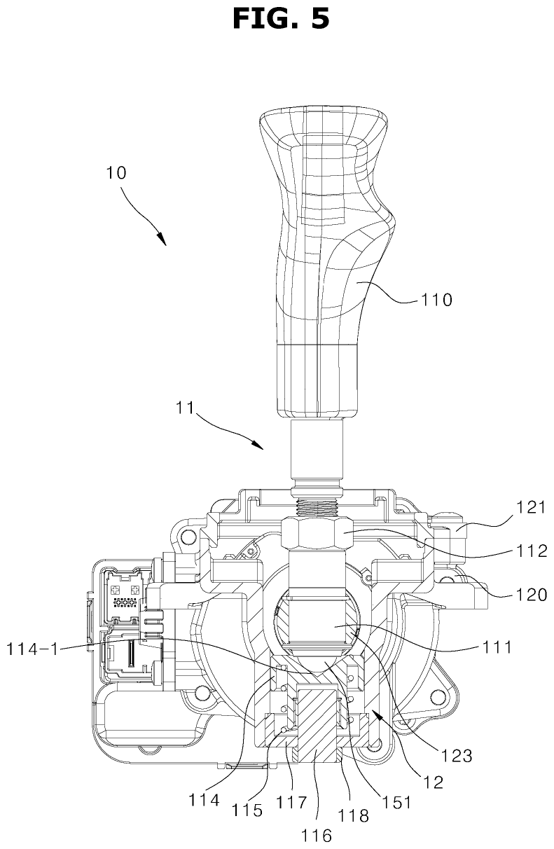

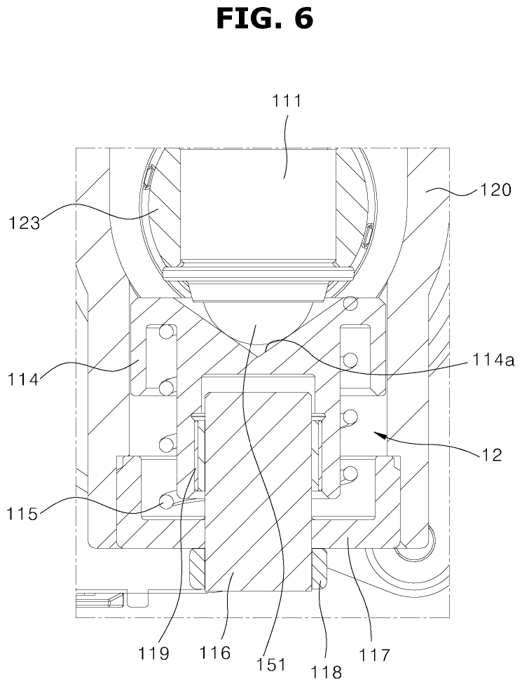

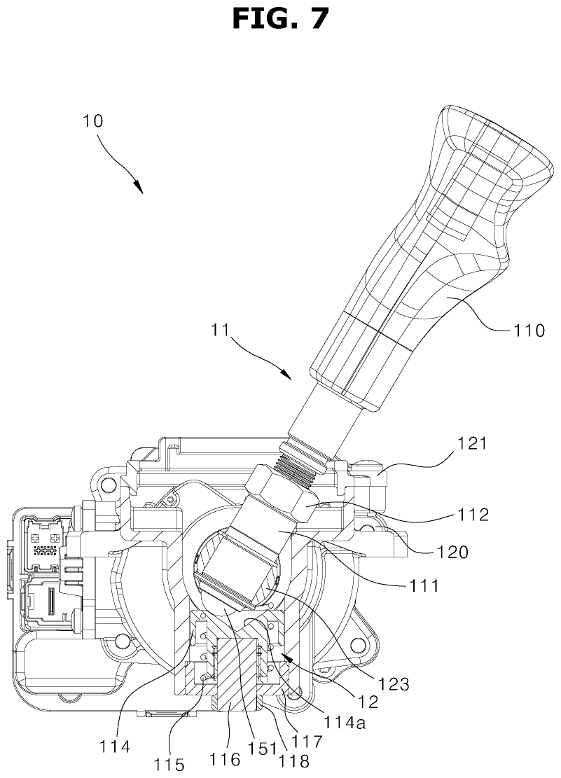

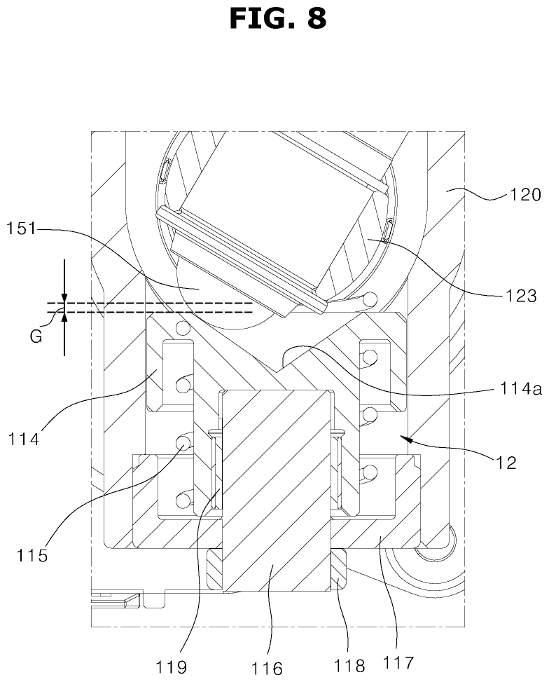

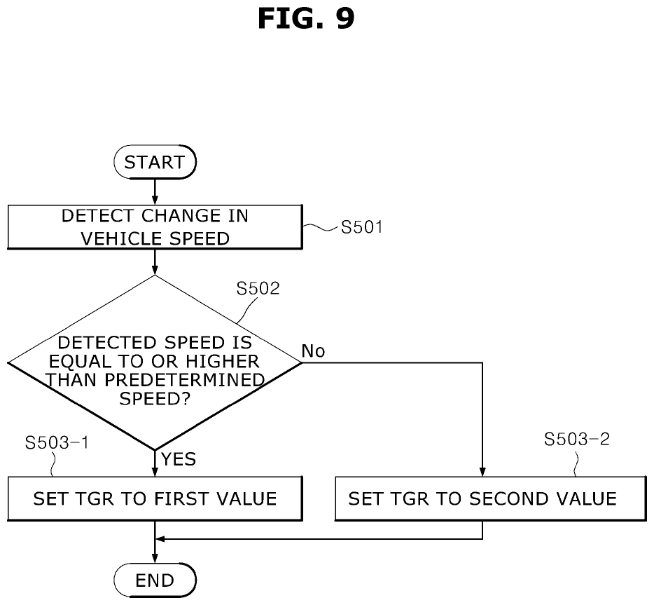

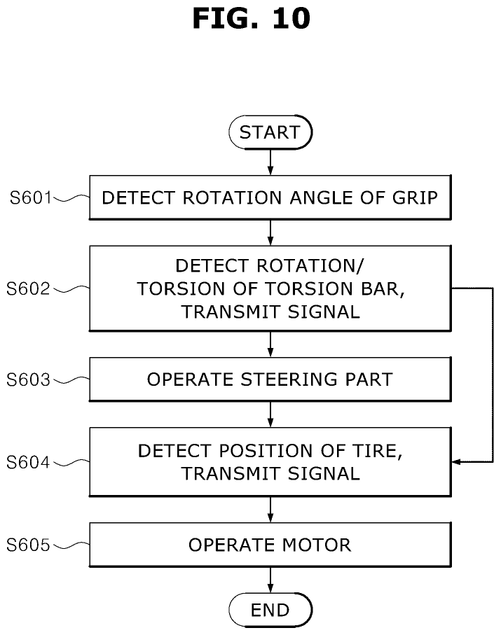

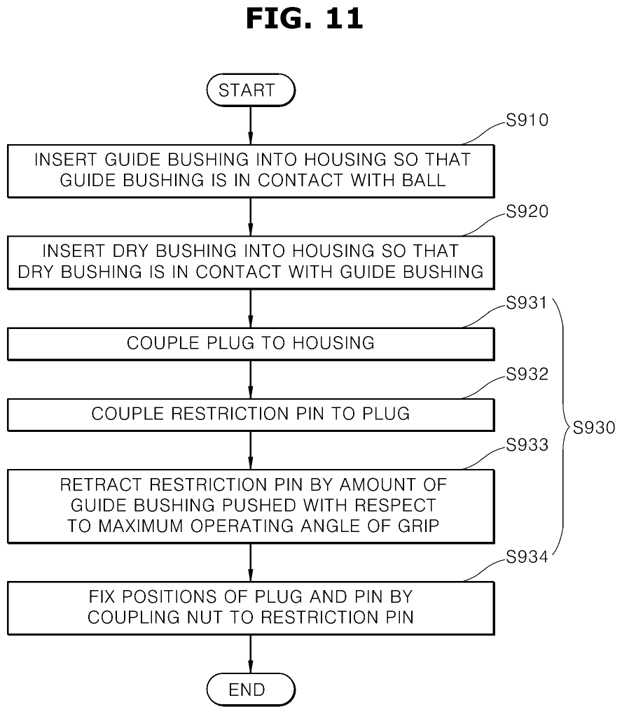

FIG. 1 is a perspective view of an electronic control steering system according to an embodiment of the present disclosure, FIG. 2 is a perspective view of a steering input device according to the embodiment of the present disclosure, FIG. 3 is a side view illustrating a lateral side of a part of the steering input device according to the embodiment of the present disclosure, FIG. 4 is a cross-sectional side view of the steering input device according to the embodiment of the present disclosure, FIG. 5 is a cross-sectional view of the steering input device according to the embodiment of the present disclosure taken in a direction perpendicular to a length direction, FIG. 6 is an enlarged view of a part of the steering input device illustrated in FIG. 5, FIG. 7 is a view illustrating a state in which a grip of the steering input device according to the embodiment of the present disclosure is moved, and FIG. 8 is an enlarged view of a part of the steering input device illustrated in FIG. 7. FIG. 9 is a control flowchart for the steering input device according to the embodiment of the present disclosure, and FIG. 10 is a control flowchart for the electronic control steering system according to the embodiment of the present disclosure. FIG. 11 is a flowchart for a method of manufacturing the steering input device according to the embodiment of the present disclosure.

With reference to FIGS. 1 to 8, an electronic control steering system 1 may be applied to a vehicle. The electronic control steering system 1 may include a steering input device 10, a steering part 20, and a signal transmitting/receiving part 30.

A user or driver may input a steering angle through the steering input device 10, and the vehicle may travel in response to the inputted steering angle. The steering angle may be inputted by the user, and an input value related to the steering angle may be transmitted to the steering part 20 through a wired or wireless signal. The input value related to the steering angle may be transmitted to the steering part 20 through the signal transmitting/receiving part 30. The steering part 20 may change a steering angle of a tire by moving a tie rod as an output related to the signal value transmitted from the steering input device 10.

With reference to FIGS. 1 to 4, the steering input device 10 may include a grip part 11, a reaction force generation part 12, a connection part 13, and a drive part 14.

The grip part 11 may rotate about at least a part of the steering input device 10. The grip part 11 is a portion configured to be held by the user with hand. The grip part 11 may be rotated by the user's manipulation. The steering angle, which is to be inputted, may vary depending on a degree to which the grip part 11 rotates. At least a part of the grip part 11 may be disposed in an input part housing 120. The grip part 11 may include a grip 110, a grip shaft 111, a grip nut 112, and a grip cover 113.

The reaction force generation part 12 may be disposed below the grip part 11. The reaction force generation part 12 according to the embodiment may include the input part housing 120, an input part cover 121, and a first port 122.

The input part housing 120 may be disposed below the grip 110. The input part cover 121 may be disposed above the input part housing 120. The grip 110 may penetrate a hole formed in the input part cover 121. At least a part of the grip 110 may be disposed in the input part housing 120.

The first port 122 may output a signal value related to a degree to which the grip 110 or the connection part 13 is rotated. The degree to which the grip 110 or the connection part 13 is rotated may be detected by a sensor 125. The signal value related to the degree to which the grip 110 or the connection part 13 is rotated may be a value detected by the sensor 125. The first port 122 may be connected to the signal transmitting/receiving part 30.

A connection part housing 130 may be disposed at one side of the input part housing 120 and connect the input part housing 120 and a motor housing 140.

An upper shaft 131 may be disposed in the connection part housing 130. The upper shaft 131 may be connected to the grip 110 and a motor 141, which is disposed in the motor housing 140, so that the upper shaft 131 may transmit power.

The drive part 14 may transmit a reaction force, which is transmitted from the tire connected to the steering part 20, to the connection part 13, and the connection part 13 may transmit the reaction force to the grip part 11.

The reaction force, which is generated by the reaction force generation part 12 connected to the grip part 11, may be transmitted to the grip part 11. The reaction force generated by the reaction force generation part 12 may vary depending on a degree to which the grip part 11 and the connection part 13 rotate.

The motor 141 may adjust a position of the grip 110 so that a position of the grip 110 is matched with a position of the tire, i.e., the position of the grip 110 and the position of the tire are synchronized when the tire is restored by reverse input, and the motor 141 may inform the user of the position of the tire.

The grip 110 may be disposed to penetrate the grip cover 113 and the input part cover 121. The grip 110 may be connected to the grip shaft 111 by means of the grip nut 112. The grip nut 112 may rotate, and a height of the grip 110 from the grip cover 113 may be changed by the rotation of the grip nut 112.

The grip shaft 111 may be connected to a lower shaft 123, and the lower shaft 123 may be rotated by the rotation of the grip 110 connected to the grip shaft 111. The lower shaft 123 may be disposed below the grip 110 connected to the grip shaft 111.

The grip shaft 111 may be connected to the lower shaft 123 and extend to a side below the lower shaft 123 while penetrating the lower shaft 123.

The reaction force generation part 12 may include a guide bushing 114, a spring 115, and a plug part. The plug part may include a restriction pin 116, a plug 117, and a plug nut 118.

The guide bushing 114 may be disposed below the lower shaft 123, and the spring 115 may be disposed on an outer periphery of the guide bushing 114. The plug part may be disposed below the guide bushing 114 and the spring 115.

The reaction force generation part 12 may further include a ball 151 or a roller. The ball 151 or the roller may be disposed between the grip shaft 111 and the guide bushing 114. The ball 151 is connected to an end of the grip shaft 111. The ball 151 may be provided separately from the grip shaft 111 and rotatably or slidably coupled to the grip shaft 111. In addition, the ball 151 may be integrated with the grip shaft 111.

The ball 151 may be in contact with the grip shaft 111 and the guide bushing 114. The ball 151 may be disposed to be always in contact with the guide bushing 114. The spring 115 may be disposed between the guide bushing 114 and the plug 117. Therefore, the spring 115 may elastically press the guide bushing 114 in a state in which a lower end of the spring 115 is supported by the plug 117. The spring 115 elastically presses the guide bushing 114 toward the lower shaft 123 or the grip 110.

When the grip 110 rotates, the ball 151 moves, and thus the guide bushing 114 moves downward. As a rotation angle of the grip 110 increases, a degree to which the ball 151 presses the guide bushing 114 downward increases. In this case, the spring 115 is compressed by the downward movement of the guide bushing 114, and a reaction force is applied to the grip 110 by the compressed spring 115. Therefore, the user feels the reaction force when the grip 110 operates.

When an external force applied to the grip 110 by the user is eliminated, i.e., when an operating force applied to the grip 110 is eliminated, the compressed spring 115 is restored, and the grip 110 is also restored to an original position. The spring 115 provides a mechanically reaction force to the user. The spring 115 may restore the position of the grip 110 to an origin even in a situation in which the vehicle is turned off and the motor 141 does not operate. The mechanical reaction force generated by the spring 115 may cause a deviation of a reaction force load in accordance with the rotation angle of the grip 110. In this case, a driving load of the motor 141 may reduce the deviation of the reaction force load.

The sensor 125 may be disposed at a first side of the lower shaft 123 (a side adjacent to the motor housing 140). The sensor 125 may measure the rotation angle of the lower shaft 123. The sensor 125 may measure torque, a steering angle, an angular velocity, and the like of the lower shaft 123. The motor 141 may rotate a motor shaft 144 on the basis of the torque, the steering angle, the angular velocity, and the like that are measured by the sensor 125.

The reaction force generation part 12 may further include a lower bearing 124 disposed at a second side of the lower shaft 123 (a side opposite to the motor housing 140). The lower bearing 124 may be disposed in the input part housing 120, maintain a constant rotation center (axis) of the lower shaft 123, and reduce a rotational friction force of the lower shaft 123.

The connection part 13 may be rotatably supported on the input part housing 120. The connection part 13 may include the lower shaft 123, the upper shaft 131, and the connection part housing 130.

The lower shaft 123 may be connected to the upper shaft 131 disposed at the first side. The lower shaft 123 and the upper shaft 131 may extend in a row along a connection part axis extending horizontally.

The connection part 13 may further include an upper bearing 132 that surrounds an outer peripheral surface of the upper shaft 131. The upper bearing 132 may be disposed in the connection part housing 130, maintain a constant rotation center (axis) of the upper shaft 131, and reduce a rotational friction force of the upper shaft 131.

The connection part 13 may further include a connection guide 133 disposed at a first side of the upper shaft 131 (the side adjacent to the motor housing 140). The upper shaft 131 may penetrate the connection guide 133 and be coupled to a constituent element disposed in the motor housing 140.

The connection guide 133 may maintain a constant rotation center (axis) of the upper shaft 131. The connection guide 133 may be connected to the upper shaft 131 and the motor shaft 144 to be described below and guide the connection between the upper shaft 131 and the motor shaft 144.

The drive part 14 may include the motor 141, the motor shaft 144, and the motor housing 140. The motor 141 and the motor shaft 144 may be disposed in the motor housing 140. The motor shaft 144 is connected to the motor 141 and rotated by power transmitted from the motor 141.

The drive part 14 may further include a motor bearing 143 disposed between the motor shaft 144 and the motor housing 140. The motor bearing 143 may maintain a constant rotation center (axis) of the motor shaft 144 and reduce a rotational friction force of the motor shaft 144. The motor shaft 144 may be connected to the upper shaft 131 and transmit a rotational force of the motor 141 to the upper shaft 131.

The drive part 14 may further include a motor controller 145. The motor controller 145 may be disposed in the motor housing 140 and rotate the motor shaft 144 by controlling the motor 141.

The drive part 14 may further include a second port 142 connected to the motor controller 145. A signal may be transmitted and received through the second port 142.

The drive part 14 may be connected to the connection part 13 and provide power for rotating the connection part 13 and the grip 110 in accordance with a steering angle of a driving wheel (not illustrated) of the vehicle. The grip 110 and the connection part 13, which are inclined at a particular angle, may be restored to original positions by rotational power generated by the motor shaft 144 of the drive part 14.

The steering input device 10 may further include a torsion bar 150. The lower shaft 123 and the upper shaft 131 may be connected directly to each other. The torsion bar 150 may be disposed in the lower and upper shafts 123 and 131. One side of the torsion bar 150 may be inserted into the lower shaft 123, and the other side of the torsion bar 150 may be inserted into the upper shaft 131.

The torsion bar 150 may be connected to the lower shaft 123 and the upper shaft 131. A rotational force of the lower shaft 123 may be transmitted to the torsion bar 150, and the transmitted rotational force may be transmitted to the upper shaft 131 through the torsion bar 150. The transmission direction is not limited thereto. The rotational force may be transmitted from the upper shaft 131 to the torsion bar 150 and the lower shaft 123.

Torque, i.e., a torsional force may be applied to the torsion bar 150 because of a difference in rotational force between the upper shaft 131 and the lower shaft 123. For example, in case that the grip 110 is inclined at a particular angle from the original position with respect to the connection part axis, a torsional force may be applied to the torsion bar 150.

The torque applied to the torsion bar 150 may be measured by the sensor 125. The sensor 125 may detect torque applied to the torsion bar 150, a rotation angle of the lower shaft 123, and the like, convert the detected information into an electronic signal, and transmit and receive the electronic signal to and from the outside of the steering input device 10 through the first port 122. The value measured by the sensor 125 may be transmitted to the steering part 20, and the steering angle may be changed.

The sensor 125 may be a torque angle sensor. In case that the grip 110 is inclined at a particular angle from the original position, the sensor 125 may detect a torsional force of the torsion bar 150 and measure a rotation angle, torque, and the like of the connection part 13.

The driving wheel (not illustrated), i.e., the tire of the vehicle may be steered on the basis of the rotation angle, the torque, and the like measured by the sensor 125. The sensor 125 may be installed on a boundary between the lower shaft 123 and the upper shaft 131. The sensor 125 may be connected to and communicate with an ECU of the vehicle.

With reference to FIGS. 5 and 6, the grip shaft 111 connected to the grip 110 may be disposed in parallel in a vertical direction. A state of the grip 110 in this state is defined as a ‘first state’.

The ball 151 may be disposed below the grip shaft 111. A rotation center of the ball 151 may move along the grip shaft 111, and the ball 151 may rotate about a rotation center.

A bushing groove 114a may be formed in a central portion of the guide bushing 114. The bushing groove 114a may be formed as a groove formed concavely from the guide bushing 114 toward the plug part, i.e., the restriction pin 116. The bushing groove 114a may have conical shape or a cross-section of the bushing groove 114a may have a triangular shape. However, the present disclosure is not limited thereto. The bushing groove 114a may have other shapes, as necessary.

The ball 151 may be seated in the bushing groove 114a. The ball 151 may have a spherical or cylindrical shape. A roller may be disposed instead of the ball 151. The ball 151 may rotate in a state of being in contact with the bushing groove 114a.

The restriction pin 116 of the plug part may restrict a movement range of the guide bushing 114. The restriction pin 116 may be disposed below a movement route for the guide bushing 114 and inserted into the guide bushing 114. In case that the guide bushing 114 moves a predetermined distance or longer, an additional movement of the guide bushing 114 may be restricted by the restriction pin 116.

The restriction pin 116 may be provided separately from the plug 117 and screw-coupled to the plug 117. The plug 117 may move on the restriction pin 116 in a direction toward or away from the guide bushing 114.

The plug nut 118 may be screw-coupled to the restriction pin 116. A position on the plug nut 118 screw-coupled to the restriction pin 116 may move in a length direction of the restriction pin 116. The plug 117 may be supported by the plug nut 118. A position of the plug 117 on the restriction pin 116 may be adjusted by adjusting a position of the plug nut 118 on the restriction pin 116. The restriction pin 116 and the plug 117 may be integrated.

The spring 115 may be disposed on the outer periphery of the guide bushing 114. The spring 115 may be in contact with the guide bushing 114 and the plug 117 and may press the guide bushing 114 in a direction in which the guide bushing 114 is pushed from the plug 117. Therefore, a restoring force may be applied to the grip 110 by the spring 115.

A dry bushing 119 may be disposed inside the guide bushing 114. The dry bushing 119 may be disposed between the plug part, specifically, the restriction pin 116 and the guide bushing 114 and prevent or reduce friction between the restriction pin 116 and the guide bushing 114. The dry bushing 119 may be made of a material having a frictional coefficient smaller than a frictional coefficient of the guide bushing 114. Therefore, the guide bushing 114 may move upward or downward relative to the plug 117.

With reference to FIGS. 7 and 8, the grip shaft 111 connected to the grip 110 may be disposed obliquely with respect to the vertical direction. A state, in which the grip 110 is disposed to be inclined with respect to the vertical direction by the user's manipulation or the like as described above, is defined as a ‘second state’. The second state of the grip 110 is illustrated in FIGS. 7 and 8.

When the grip 110 rotates about the lower shaft 123, the ball 151 connected to the lower side of the grip 110 presses the guide bushing 114 toward the plug 117, i.e., downward. The guide bushing 114 moves toward the plug 117 by a gap G by which the ball 151 presses the guide bushing 114.

In this case, the spring 115 is compressed by the gap G. When the spring 115 is compressed by the gap G, the spring 115 presses the ball 151 through the guide bushing 114, and the user feels the reaction force applied to the grip 110. Therefore, the amount of compression of the spring 115 increases as the rotation angle of the grip 110 increases, and the user feels a higher reaction force. The compressed spring 115 provides a restoring force for restoring the grip 110 to the first state when the external force applied to the grip 110, e.g., the user's operating force is eliminated.

A method of controlling a total gear ratio (TGR) of the steering input device according to the embodiment of the present disclosure will be described with reference to FIG. 9.

The TGR may be a total gear ratio, i.e., a ratio of a tire steering angle that varies depending on a rotation angle of the grip 110. When a TGR value is large, the tire steering angle may be large even when the rotation angle of the grip 110 is small. When the TGR value is small, the tire steering angle may be small even when the rotation angle of the grip 110 is large.

The electronic control steering system 1 may further include a controller C. The controller C may detect a speed of the vehicle and a change in speed (S501). The controller C may determine whether the detected speed of the vehicle is equal to or higher than a preset speed (S502).

In case that the detected speed of the vehicle is equal to or higher than the preset speed, the controller C sets the TGR to a first value (S503-1). In case that the detected speed of the vehicle is lower than the preset speed, the controller C sets the total gear ratio (TGR) to a second value (S503-2).

The first value may be smaller than the second value. Therefore, when the speed of the vehicle is higher than the preset speed, the TGR is set to be as small as the first value, such that the steering angle of the vehicle may be set to be small even when the user rotates the grip 110 greatly. In addition, when the speed of the vehicle is lower than the preset speed, the TGR is set to be as large as the second value larger than the first value, such that the steering angle of the vehicle may be set to be large even when the user rotates the grip 110 slightly.

For example, when the speed of the vehicle is higher than the preset speed, the TGR is set to be small, such that the tire may be steered only at 5 degrees even when the grip 110 rotates at 10 degrees. Likewise, when the speed of the vehicle is lower than the preset speed, the TGR is set to be large, such that the tire may be steered at 20 degrees when the grip 110 rotates at 10 degrees.

In S502, the preset speed may vary depending on in accordance with an environment and design of the vehicle. A plurality of criteria, instead of a single criterion, may be provided to divide the preset speed. For example, the speed of the vehicle may be divided into a first section, a second section, and a third section. The TGR value may be set to the first value in case that the speed of the vehicle is included in the first section. The TGR value may be set to the second value in case that the speed of the vehicle is included in the second section. The TGR value may be set to a third value when the speed of the vehicle is included in the third section.

Because the TGR value varies depending on the speed of the vehicle as described above, the steering angle of the vehicle is small even when the user rotates the grip 110 greatly while the vehicle travels at high speed. Therefore, it is possible to ensure traveling stability. In addition, the steering angle of the vehicle is large even when the user rotates the grip 110 slightly while the vehicle travels at low speed. Therefore, the vehicle may be quickly steered, which may improve user convenience.

A method of controlling the electronic control steering system according to the embodiment of the present disclosure will be described with reference to FIG. 10.

When the user rotates the grip 110, the controller C may detect a rotation angle of the grip 110 by means of the sensor 125 (S601).

The lower shaft 123 and the upper shaft 131 may be rotated by the rotation of the grip 110, and torque (torsional force) may be applied to the torsion bar 150 connected to the lower shaft 123 and the upper shaft 131. The controller C may detect the rotations of the lower and upper shafts 123 and 131 by means of the sensor 125 and detect the torque applied to the torsion bar 150. In addition, the controller C may transmit a torque value, which is detected by the sensor 125, to the steering part 20 (S602).

The controller C may set the steering angle by operating the steering part 20 on the basis of the value detected by the sensor 125 (S603).

The controller C may detect a position of the tire connected to the steering part 20, convert the detected value into a signal, synthesize the converted signal with a signal transmitted to the steering part 20 in S602, and transmits the synthesized signal to the motor 141 (S604).

The controller C may adjust the rotation angle of the grip 110 by operating the motor 141 on the basis of the synthesized signal. The controller C may operate the motor 141 in consideration of the reaction force generated by the spring 115 (operation S605).

As described above, the steering angle of the tire is set by the rotation of the grip 110, and the reaction force is transmitted to the user through the grip 110 in consideration of the position of the tire and the reaction force of the spring, such that the user may accurately recognize the position of the tire by means of the grip 110.

When the user does not operate the grip 110 any further after the steering part 20 is operated in response to the signal of the grip 110, the steering part 20 may be restored to the origin by a reverse input of the tire. In this case, the user may receive a current state, which includes the position of the tire, through the grip 110. The motor 141 may adjust the position of the grip 110 so that the position of the tire position and the position of the grip 110 are matched with each other.

A method of manufacturing the steering input device according to the embodiment of the present disclosure will be described with reference to FIG. 11.

The method of manufacturing the steering input device 10 according to the embodiment of the present disclosure may include a step of disposing the connection part 13 so that the connection part 13 is connected to the grip part 11. The connection part 13 may be rotated by the rotation of the grip part 11.

The method may include step S910 of disposing or inserting the guide bushing 114, which is in contact with the grip part 11 and moved by the rotation of the grip part 11, into the input part housing 120. The guide bushing 114 may be disposed below the grip shaft 111. The roller (or the ball 151) may be disposed below the grip shaft 111.

The method may include step S920 of disposing the dry bushing 119 so that the dry bushing 119 is in contact with the guide bushing 114. The dry bushing 119 may be disposed on at least a part of the guide bushing 114 and reduce friction generated between the guide bushing 114 and the restriction pin 116.

Step S920 of disposing the dry bushing 119 so that the dry bushing 119 is in contact with the guide bushing 114 may be performed prior to step S910 of disposing or inserting the guide bushing 114 into the input part housing 120 or performed subsequent to step S910 of disposing or inserting the guide bushing 114 into the input part housing 120. The present disclosure is not limited to the order of step S910 and step S920.

The method may include step S930 of disposing the reaction force generation part 12, which is configured to generate the reaction force in response to the rotation of the grip part 11, in the input part housing 120.

Step S930 of disposing the reaction force generation part 12 in the input part housing 120 may include operation S931 of coupling the plug 117 to the input part housing 120, operation S932 of coupling the restriction pin 116 to the plug 117, operation S933 of retracting the restriction pin 116 by the amount G of the guide bushing pushed with respect to a maximum operating angle of the grip 110, and operation S934 of fixing the positions of the plug 117 and the restriction pin 116 by coupling the restriction pin 116 and the plug nut 118.

Operation S931 of coupling the plug 117 to the input part housing 120 may be performed prior to operation S932 of coupling the restriction pin 116 to the plug 117 or performed subsequent to operation S932 of coupling the restriction pin 116 to the plug 117. The present disclosure is not limited to the order of operation S931 and operation S932.

In operation S933, when the grip 110 is rotated at a maximum operating angle, the amount of the guide bushing 114 pushed may be generated by the gap G illustrated in FIG. 8. When the restriction pin 116 is fixed in a state in which the guide bushing 114 is maximally pushed, a movement range of the guide bushing 114 may be restricted by the restriction pin 116. When the restriction pin 116 is retracted (moved) after the grip 110 is rotated at the maximum operating angle as described above, the rotation angle of the grip 110 may be restricted by the restriction on the movement range of the guide bushing 114.

As described above, the restriction pin 116 and the plug 117 may be provided separately from each other, and the restriction pin 116 may be screw-coupled to the plug 117. The movement range of the guide bushing 114 may be variably set as the restriction pin 116 moves relative to the plug 117, and thus the rotation angle of the grip 110 may also be variably set. In addition, in case that the restriction pin 116 and the plug 117 are provided separately from each other, the rotation angle of the grip 110 may be variably set despite an error that occurs during the process of manufacturing the restriction pin 116 and the plug 117. Further, the amount of time required to correct an error during the process of assembling the reaction force generation part 12 may be further reduced in the case in which the restriction pin 116 and the plug 117 are provided separately from each other than in a case in which the restriction pin 116 and the plug 117 are integrated.

While the present disclosure has been described with reference to the embodiments depicted in the drawings, the embodiments are for illustrative purposes only, and those skilled in the art to which the present technology pertains will understand that various modifications of the embodiments and any other embodiments equivalent thereto are available. In addition, the present disclosure may be used for the other fields. Accordingly, the true technical protection scope of the present disclosure should be determined by the appended claims.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A steering input device comprising:
a grip part;
a lower shaft engaged to the grip part and configured to be rotated by a rotation of the grip part;
a torsion bar, an end portion of which is connected to the lower shaft, wherein the torsion bar is at least partially disposed in the lower shaft;
an upper shaft connected to the torsion bar and accommodating at least a part of the torsion bar, the upper shaft being connected to the lower shaft;
a sensor configured to detect a rotation angle of the lower shaft or the upper shaft; and
a motor shaft connected to the upper shaft and coupled to a motor to be rotated by the motor.

2. The steering input device of claim 1, further comprising:
an input part housing accommodating at least a part of the grip part;
a ball disposed in the input part housing and connected to the grip part;
a guide bushing contacting with the ball in a direction opposite to the grip part; and
a spring disposed in the input part housing and configured to elastically support the guide bushing in a direction toward the ball.

3. The steering input device of claim 2, wherein the sensor is configured to detect a torque applied to the torsion bar by a difference in a rotational force between the upper shaft and the lower shaft.

4. The steering input device of claim 3, wherein a bushing groove is formed in a portion of the guide bushing that is in contact with the ball, and the spring presses the guide bushing toward the ball so that the ball is in contact with the guide bushing.

5. The steering input device of claim 4, further comprising:
a plug disposed in the input part housing and configured to support the spring at a side opposite to the guide bushing; and
a dry bushing disposed inside the guide bushing and outside the plug.

6. The steering input device of claim 2, further comprising:
a first port disposed outside the input part housing and connected to the sensor; and
a second port connected to a motor controller disposed in a motor part housing that accommodates the motor shaft,
wherein the motor is configured to operate based on a signal inputted through the second port.

7. The steering input device of claim 1, further comprising:
a connection guide connected the upper shaft and the motor shaft.

8. The steering input device of claim 1, wherein the grip part includes:
a grip shaft coupled to the lower shaft;
a grip cover; and
a grip nut coupling the grip shaft and the grip cover so that a height of the grip shaft from the grip cover is adjusted in response to rotation of the grip nut.

9. A method of controlling an electronic control steering system comprising a steering input device, a steering part engaged to the steering input device, and a controller electrically and communicatively connected to the steering input device and the steering part, the method comprising:
detecting, by a sensor electrically and communicatively connected to the controller, a speed of a vehicle;
determining, by the controller, whether the detected speed of the vehicle is equal to or higher than a preset speed; and
setting, by the controller, a total gear ratio value to a first value upon concluding that the detected speed of the vehicle is equal to or higher than the preset speed, and setting, by the controller, the total gear ratio value to a second value, which is larger than the first value, upon concluding that the detected speed of the vehicle is lower than the preset speed,
wherein the total gear ratio value is a ratio of a tire steering angle to a rotation angle of a grip part of the steering input device.

10. The method of claim 9, further comprising:
detecting, by the controller, a rotation angle of the grip part;
detecting, by the controller, a rotation angle and a torque of a torsion bar of the steering input device and transmitting, by the controller, a signal to the steering part;
setting, by the controller, the tire steering angle by operating the steering part in response to the signal transmitted to the steering part;
detecting, by the controller, a position of a tire steered by the operation of the steering part and transmitting, by the controller, a signal related to the position of the tire to the steering input device; and
setting, by the controller, a rotation angle of the grip part by operating a motor in response to the signal transmitted to the steering input device.

11. The method of claim 10, wherein the transmitting of the signal related to the position of the tire to the steering input device comprises:
detecting a rotation angle and a torque of the torsion bar;
synthesizing a signal transmitted to the steering part and a signal related to the position of the tire; and
transmitting the synthesized signal to the steering input device.

12. A steering input device comprising:
a grip part;
a connection part engaged to the grip part and configured to be rotated by a rotation of the grip part;
an input part housing accommodating the grip part and the connection part; and
a reaction force generation part coupled to the input part housing and configured to generate a reaction force that varies depending on the rotation of the grip part,
wherein the reaction force generation part comprises:
a guide bushing being in contact with the grip part and configured to be moved by the rotation of the grip part; and
a restriction pin configured to restrict a movement range of the guide bushing.

13. The steering input device of claim 12, wherein the reaction force generation part further comprises a plug coupled to the input part housing, and the restriction pin is coupled to the plug so that a distance of the plug from the guide bushing is adjusted in response to adjusting of a position of the plug nut on the restriction pin.

14. The steering input device of claim 13, wherein the reaction force generation part further comprises a plug nut, and the plug nut is screw-coupled to the restriction pin, and configured to move in a length direction of the restriction pin in response to an external force applied there to, comes into contact with the plug, and fixes the restriction pin to the plug.

15. The steering input device of claim 13, wherein the reaction force generation part further comprises a spring, and the spring is disposed between the guide bushing and the plug to press the guide bushing toward the grip part.

16. The steering input device of claim 12, wherein a ball is provided below a grip shaft of the grip part, and the ball is seated in a bushing groove formed in the guide bushing and moves the guide bushing toward the restriction pin in accordance with a rotation of the grip shaft.

17. The steering input device of claim 12, comprising:
a sensor part configured to detect a rotation angle of the connection part; and
a motor shaft connected to the connection part and configured to be rotated by a motor.

18. The steering input device of claim 13, wherein the plug is inserted into the guide bushing, and the steering input device further comprises a dry bushing being in contact with the guide bushing and the plug to reduce friction generated between the guide bushing and the plug.

19. The steering input device of claim 12, wherein the grip part includes:
a grip shaft;
a grip cover; and
a grip nut coupling the grip shaft and the grip cover so that a height of the grip shaft from the grip cover is adjusted in response to rotation of the grip nut.
